(19) United States
(12) Patent Application Publication
(10) Pub. No.: US 2016/0301216 A1
(43) Pub. Date: Oct. 13, 2016

(54) METHOD OF DETERMINING AN ISLANDING SOLUTION FOR AN ELECTRICAL POWER SYSTEM

(71) Applicant: THE UNIVERSITY OF MANCHESTER, Greater Manchester (GB)

(72) Inventors: Vladimir TERZIJA, Manchester (GB); Jairo Quiros TORTOS, Manchester (GB); Peter WALL, Manchester (GB)

(21) Appl. No.: 15/038,704

(22) PCT Filed: Nov. 26, 2014
(86) PCT No.: PCT/GB2014/053501

§ 371 Date: May 23, 2016

(30) Foreign Application Priority Data
Nov. 26, 2013 (GB) 1320858.2

(51) Int. Cl. H02J 3/40; H02J 3/38

(52) U.S. Cl. CPC H02J 3/40; H02J 3/381; H02J 2003/388

(57) ABSTRACT

Method of determining an islanding solution for a power system comprising representing synchronising coefficients between generators and couplings between load buses and generators of the power system as a dynamic graph, calculating eigenvalues and eigenvectors of a graph laplacian describing the synchronising coefficients, identifying reference generators, calculating eigenvectors describing dynamic coupling between load buses and reference generators, using the synchronising coefficient and dynamic coupling eigenvectors to determine proximities between reference generators and other buses, assigning other buses to reference generators according to the proximities, selecting a threshold, identifying buses in weak-areas by using the threshold to identify buses having a proximity to their reference generator sufficiently similar to their proximity to another reference generator, determining the islanding solution by selecting connections to disconnect to split the power system into two or more islands based on an analysis of power flows only on connections to, or between, buses in weak-areas.

### FIELD OF THE INVENTION

The present invention relates to a method of determining an islanding solution that separates an electrical power system comprising a plurality of generator buses and load buses into r electrically isolated islands

### BACKGROUND OF THE INVENTION

An electrical power system is a network of electrical components used to generate, transmit and consume electrical power. An electrical power system includes generators, which generate the electrical power and supply the electrical power to the electrical power system, loads, which use the electrical power in the electrical power system, and transmission and distribution systems that transmit and distribute the electrical power from the generators to the loads.

Electrical power systems can be used to distribute electrical power from generators to different loads, such as different residential, business or industrial premises, in a specific geographical area. These geographical areas may range in size from a small area, e.g. a city or smaller (Micro Grids), to a large area, e.g. some or all of a country or more than one country (Mega/Super-Grids).

The generators are normally power stations (e.g. coal, gas, or nuclear power stations), or more specifically individual generators in these power stations, for example individual turbine generators. Other types of generator that may be present in electrical power systems include wind turbines, wave or tidal power generators, or essentially any other device that is capable of generating electrical power.

The transmission system for distributing the electrical power from the generators to the loads can be considered, at its most basic, as comprising a large number of transmission lines, i.e. electrically conductive paths linking different electrical components in the electrical power system. For example, the transmission system may be a network of overhead transmission lines and high voltage cables, power transformers and other passive and active components (e.g. reactive power compensators, series capacitive compensators, power inverters etc.).

The loads of an electrical power system are any devices connected to the electrical power system that consume electrical power, for example a place of residence or a business or industrial premises.

To maximize profit, many electrical power systems operate relatively close to their stability limits, i.e. there is not much spare capacity in the electrical power system to respond to different types of faulty conditions, as well as to cope with sudden increases or decreases in demand for electrical power, or with sudden decreases in the generation and supply of electrical power. Therefore, large electrical power system disturbances, for example a large drop in electrical power generation or distribution due to disruption to one or more generators or to the transmission system from events such as earthquakes, hurricanes, flooding, fire, unexpected shutdowns, etc., may cause the electrical power system to become unstable and to lose its integrity.

Instability in the electrical power system may cause localised or wide-spread cascading outages in the electrical power system, localised or wide-spread brownouts (i.e. a drop in the voltage of the electrical power supply) or blackouts (i.e. a total loss of electrical power supply) or even a total electrical power system collapse (i.e. a blackout across the whole system caused by all of the generators going offline).

If the integrity of the entire electrical power system cannot be maintained, a potential solution is to intentionally split the electrical power system into smaller subsystems, also known as islands. This intentional and controlled islanding is preferable to the uncontrolled system separation that would otherwise occur, which would most likely lead to the creation of unstable electrical islands and risk total system collapse. By intentionally splitting the electrical power system into smaller subsystems, an approach known as intentional controlled islanding (ICI), the integrity of at least part of the electrical power system can be preserved, whereas with no action the entire electrical power system could collapse (i.e. there could be a complete loss of electrical power supply across the entire electrical power system). Controlled islanding can be used to cope with different electrical power system extremes, such as un-damped oscillations, voltage collapse, cascading trips, etc.

The electrical power system can be intentionally split into smaller subsystems by intentionally disconnecting specific transmission lines in the electrical power system. Determining an appropriate intentional controlled islanding solution consists of two main steps. The first of these steps is to define the generators of the electrical power system that should remain in the same interconnected coherent group of generators. A large disturbance in an electrical power system can initiate un-damped electromechanical oscillations. These electromechanical oscillations can cause generators to lose their coherency. To create stable islands, the generators within any island formed must operate synchronously, i.e. must have the same frequency. This can be achieved by assessing the synchronising coefficients between each of the generators in the electrical power system. The result of this assessment is a set of coherent groups of generators, i.e. definitions of which generators should be kept together and which should be kept separate when the grouping is performed.

The second of these steps is to find the optimal splitting solution for splitting the electrical power system into separate islands. To split the power system, a Splitting Strategy (SS) must be determined. The main objective when determining a SS is to define the set of transmission lines that must be disconnected across the electrical power system in order to create isolated and stable electrical islands and to prevent the cascading loss of assets, which can lead to a total system blackout. When determining this set of transmission lines, a large number of constraints, including generator coherency, load-generation balance, thermal limits, voltage stability, and transient stability should be taken into account. In particular, numerous dynamic and static constraints, such as transient stability, frequency stability, overloading conditions, voltage stability etc. will govern the optimal identification of the transmission lines that need to be disconnected across the electrical power system. Furthermore, it is essential to avoid overloading the transmission lines that will remain in service after the controlled electrical power system separation.

However, it is impractical, or even impossible, to find the solution of the splitting problem whilst including all possible constraints due to the size and complexity of the problem. In practice, an adequate islanding solution can sometimes be obtained by considering only a defined subset of the constraints. Thus, researchers are focused on finding practical methods that include the critical constraints, whilst limiting the complexity of the problem formulation to a reasonable and practically acceptable level. The exclusion of constraints and the inherent characteristics of the electrical power system will mean that extra corrective measures, such as under-frequency (voltage) load shedding schemes and generation curtailment, will be necessary to ensure that the islands will retain their stability in the post-splitting stage.

The existing ICI methods can be grouped according to the objective function they use: a) minimal dynamic coupling (for example, see S. S. Lamba et at (“Coherency identification by the method of weak coupling”, Electrical Power & Energy Systems, vol. 7, no. 4, pp. 233-242, October 1985)), b) minimal power imbalance (for example, see C. Wang, et al (“A novel real-time searching method for power system splitting boundary”, IEEE Trans. Power Syst., vol. 25, no. 4, pp. 1902-1909 November 2010)), or c) minimal power flow disruption (for example, see L. Ding et al (“Two-step spectral clustering controlled islanding algorithm”, IEEE Trans. Power Syst., vol. 28, no. 1, pp. 75-84, February 2013)). Several ICI methods are based on the theory of slow coherency (for example see S. B. Yusof et al (“Slow coherency based network partitioning including load buses”, IEEE Trans. Power Syst., vol. 8, no. 3, pp. 1375-1382, August 1993)). To determine the ICI solution, these methods base their analyses on identifying groups of coherent generators. In S. B. Yusof et at the concept of slow coherency was extended to group both generators and load buses considering their electrical proximity.

Based on a dynamic assessment of the system, small changes in the SS were obtained in H. You et al (“Slow coherency—Based islanding”, IEEE Trans. Power Syst., vol. 19, no. 1, pp. 483-491, February 2004) across a concentrated area when the location, the size of the disturbance, and loading conditions change.

More recently, approaches for finding the SS using Ordered Binary Decision Diagram (OBDD) methods are proposed in K. Sun et al (“Splitting strategies for islanding operation of large-scale power systems using OBDD-based methods,” IEEE Trans. Power Syst., vol. 18, no. 2, pp. 912-922, May 2003) and Q. Zhao et al (“A study of system splitting strategies for island operation of power system: A two-phase method based on OBDDs”, IEEE Trans. Power Syst., vol. 18, no. 4, pp. 1556-1565, November 2003). Since these two approaches take into consideration only static constraints, transient simulations are presented in K. Sun et al (“A simulation study of OBDD-based proper splitting strategies for power systems under consideration of transient stability”, IEEE Trans. Power Syst., vol. 20, no. 1, pp. 389-399, February 2005) to evaluate the dynamic response of the created islands. As the computation time of OBDD based methods is significant and not practically acceptable for large-scale systems, reduced networks with no more than 40 nodes must be used for real-time applications (for example, see C. Wang et al). A method that uses tracing power flow to find the initial ICI solution and then refines it to obtain the Final Splitting Strategy (FSS) based on the load-generation criterion is presented in C. Wang et al. A two-step Spectral Clustering (SC) algorithm has been recently introduced in L. Ding et al (“Two-step spectral clustering controlled islanding algorithm”, IEEE Trans. Power Syst., vol. 28, no. 1, pp. 75-84, February 2013) to minimize the power flow disruption and obtain the ICI solution. In comparison to previous strategies, the computation time to find the ICI solution is significantly reduced in C. Wang et al and L. Ding et al. However, as these methods search for the ICI solution across the entire network, the computation time in large scale networks still needs to be reduced for real-time applications.

All of the above referenced documents are incorporated herein by reference.

Since network reductions might eventually lead to the loss of the optimal ICI solution, it is of great interest to develop new ICI methods that avoid this network simplification. It is also of great interest to develop new fast ICI methods capable of computing the ICI solution in real-time, considering real-time measurements and minimizing the power-flow disruption. This islanding solution should also satisfy the dynamic constraint imposed by the coherent groups of generators.

### SUMMARY OF THE INVENTION

The present invention aims to address one or more of the problems discussed above that occur with existing intentional controlled islanding methods.

According to an aspect of the present invention there is provided a method of determining an islanding solution that separates an electrical power system comprising a plurality of generator buses and load buses into r electrically isolated islands, the method comprising:
representing the synchronising coefficients between the generators of the power system and the coupling between each load bus and each generator of the power system as a dynamic graph G_{D}=(V_{D}, E_{D}, U_{D}, W_{D}),
calculating the first r eigenvalues and eigenvectors of a graph laplacian that describes the synchronising coefficients between the generators of the power system;
identifying r reference generator buses by applying an algorithm capable of determining the most centralised data-point in the r-dimensional Euclidian space to the first r eigenvectors;
calculating the r eigenvectors that describe the dynamic coupling between each of the load buses and each of the r reference generators using the r synchronising coefficient eigenvectors and the dynamic graph;
using the r synchronising coefficient eigenvectors and the r load dynamic coupling eigenvectors to compute a measure of proximity between each reference generator and all of the other buses to calculate the proximities between each reference generator and all of the other buses;
assigning all of the other buses to reference generators according to the calculated proximities;
selecting a system threshold based on the desired size of the weak areas;
identifying buses in weak areas by applying the selected system threshold to the calculated proximities to identify buses having a proximity to their assigned reference generator that is sufficiently similar to their proximity to another reference generator;
determining the islanding solution by selecting connections to be disconnected to split the power system into two or more islands based on an analysis of power flows only on connections to, or between, the buses identified as being in weak areas.

Essentially, the weak area approach identifies the areas of the power system in which the appropriate system splitting solutions are most likely to occur based on the dynamic properties of the system. An advantage of identifying these weak areas and only considering the transmission lines within them when determining the final splitting solution is that the size of the searching space is significantly reduced. Consequently, the time necessary to find the optimal final splitting solution is also significantly reduced.

Further advantages of applying the weak area approach to intentional controlled islanding are that it is fast and robust and allows the design of islanding solutions based on multi-objective optimisation. This is in contrast to existing weak connections based approaches, which can only ever be used to optimise the islanding solution for a single objective function. This advantage is of critical importance because it is simply not possible to capture the complexity involved in the intentional controlled islanding of practical power systems through a single objective function.

Unlike with previous approaches (see L. Ding et al (“Two-step spectral clustering controlled islanding algorithm”, IEEE Trans. Power Syst., vol. 28, no. 1, pp. 75-84, February 2013)), the dynamic graph G_{D} represents the entire power system, i.e. all generation nodes and load nodes are included in the dynamic graph. Therefore, the dynamic graph G_{D} is a more complete representation of the power system.

The use of graph theory when determining the weak areas in the method of the present invention provides a further significant improvement in the computational speed of the method, relative to an approach in which the weak areas are identified using conventional algebraic techniques. As wide area blackouts in an electrical power system can occur in a matter of seconds after the initiating/triggering event, the superior computational speed of the method of the present invention can mean that a wide area blackout that could occur with conventional methods may be avoided.

Proximity may mean the distance between the vertices of the graph (buses in the electrical power system) and the reference generators when they are mapped into a projection space. These values may represent the degree of membership of each bus to each reference generator, i.e. the tendency of a bus towards being part of an island represented by the reference generator.

The above aspect of the present invention may be combined with one or more of the following optional features of the present invention.

The dynamic graph G_{D}=(V_{D}, E_{D}, U_{D}, W_{D}) may comprise two dynamic sub-graphs:

$${G}_{D} = ( {V}_{D} , {E}_{D} , {U}_{D} , {W}_{D} ) = ( {V}_{D 1} ⋃ {V}_{D 2} , {E}_{D 1} ⋃ {E}_{D 2} , {U}_{D 1} ⋃ {U}_{D 2} , {W}_{D 1} ⋃ {W}_{D 2} )$$

wherein:
the elements v_{D1,i} ε V_{D1} denote nodes of the first dynamic sub-graph, which represents the power system reduced to only the internal generator buses, when each generator is modelled using a classical 2^{nd} order generator model;
the elements v_{D2,i} ε V_{D2} denote nodes of the second dynamic sub-graph, which represents the whole dynamic power system;
the elements e_{D1,ij} ε E_{D1} denote edges of the first dynamic sub-graph, which represent the connections between the internal buses of the machines;
the elements e_{D2,ij} ε E_{D2} denote edges of the second dynamic sub-graph, which represent the connections between the buses of the whole dynamic power system;
the values u_{D1,i}=u_{D1}(v_{D1,i}) denote weight factors associated with the nodes of the first dynamic sub-graph, that represent the inertia constants of the generation at each bus;
the values u_{D2,ij}=u_{D2}(v_{D2,i}) denote weight factors associated with the nodes of the second dynamic sub-graph, that represent the inertia constants of the buses of the whole dynamic graph;
the values w_{D1,ij}=w_{D}(v_{D1,ij}) denote weight factors representing the synchronising coefficients between connected buses, associated with the edges of the first dynamic sub-graph, when considering only the internal generator buses;
the values w_{D2,ij}=w_{D2}(e_{D2,ij}) denote weight factors representing the dynamic coupling between load buses, associated with the edges of the second dynamic graph.

Using two sub-graphs in the method may be more efficient than using a single graph, because several redefinitions of edge weights and/or admittance matrices may be required in methods where a single graph is used.

The method may comprise determining the graph laplacian, A, that describes the synchronising coefficients between the generators of the power system by the following equation:

$$A = {[ M ]}^{- 1} {L}_{D 1}$$

$$where {: \\ [ M ]}_{ij} = {diag ( {u}_{D 1 , 1} , {u}_{D 1 , 2} , … , {u}_{D 1 , {n}_{g}} ) \\ [ {L}_{D 1} ]}_{ij} = \{ \begin{matrix}- {w}_{D 1 , ij} & i \neq j \\ - {\sum }_{l = 1 , l \neq i}^{{n}_{g}} {w}_{D 1 , il} & i = j\end{matrix}$$

This may represent an efficient way to determine the graph laplacian A.

Calculating the r eigenvectors that describe the dynamic coupling between each of the load buses and each of the r reference generators may comprise first computing the matrices L_{C} and L_{D} by the following:

$${[ {L}_{C} ]}_{ij} = \{ {\begin{matrix}- {w}_{D 2 , ij} & \begin{matrix}if {v}_{D 2 , i} is the terminal bus and \\ {v}_{D 2 , j} is the internal generator bus\end{matrix} \\ 0 & otherwise\end{matrix} \\ [ {L}_{D} ]}_{ij} = \{ \begin{matrix}- {w}_{D 2 , il} & \begin{matrix}if {v}_{D 2 , i} and {v}_{D 2 , j} are not internal \\ generator buses \end{matrix} \\ - {\sum }_{l = 1 , l \neq i}^{{n}_{b} + {n}_{g}} {w}_{D 2 , il} & i = j\end{matrix}$$

The r eigenvectors that describe the dynamic coupling between each of the load buses and each of the r reference generators may be determined by the following equation:

φᵥᵢ=−L_{D}⁻¹L_{C}φᵢ

where φᵢ are the synchronising coefficient eigenvectors. This may be an efficient way of determining the r eigenvectors that describe the dynamic coupling between each of the load buses and each of the r reference generators.

Alternatively, the method may comprise determining the graph laplacian, A, that describes the synchronising coefficients between the generators of the power system by the following equation:

A=J_{A}−J_{B}J_{D}⁻¹J_{C}

where the matrices J_{A}, J_{B}, J_{C} and J_{D} are determined from the following equation:

$$[ \begin{matrix}Δ \ddot{δ} \\ 0\end{matrix} ] = [ \begin{matrix}{J}_{A} & {J}_{B} \\ {J}_{C} & {J}_{D}\end{matrix} ] [ \begin{matrix}Δδ \\ Δ v\end{matrix} ]$$

where δ is an n_{g}-state vector of machine angles for the power system and V=[Vᵣ Vₓ]^{T}, where Vᵣ is an n_{b}-vector of the real component of the bus voltages of the power system and Vₓ is an n_{b}-vector of the imaginary component of the bus voltages of the power system.

The method may comprise forming an eigenbasis matrix J with the first r eigenvectors of the graph laplacian placed as column vectors before identifying the r reference generator buses. Forming the first r eigenvectors of the graph laplacian into an eigenbasis matrix J may be a convenient way of managing the eigenvectors and/or may facilitate identifying the r reference generators.

Identifying the r reference generator buses may comprise applying Gaussian elimination with complete pivoting to the eigenbasis matrix J. This may be a computationally efficient way of identifying the r reference generators.

The measure of proximity computed between each reference generator and all of the other buses may comprise the cosine similarity. Therefore, the measure of proximity may range from between −1 (meaning exactly opposite) and 1 (meaning exactly the same). The cosine similarity has been found to give better results and to be more robust in this application than the Euclidean distance and other alternative measures of proximity (or methods of determining the graph theoretic distance). However, other approaches may still give satisfactory results.

The system threshold may be selected to identify buses having a calculated proximity to their assigned reference generator that is within ±10%, ±20% or ±50% of their proximity to another reference generator. System thresholds within this range have been found to be particularly suitable. However, essentially the system threshold may take any value that is greater than zero (which would reduce the WAs to the WCs) and that is less than 100%. With a threshold value of 100% all of the non-generator buses would lie within the WA. This would mean that the complexity of the problem would not be reduced at all relative to the conventional approaches discussed above. In practice, the threshold must be large enough to allow some leeway in finding a reduced power flow disruption solution but small enough to offer tangible benefits in terms of reducing the complexity of the problem. The absence of a physical link between the proximity measure and the system size/topology may mean that an appropriate method for selecting the system threshold may be to use a heuristic approach based on experience and familiarity with the system. However, system thresholds of ±10%, ±20% or ±50% have been shown to give good results for a wide range of different system sizes and topologies.

A matrix J_{g} may be formed by applying the measure of proximity between each reference generator and all of the other buses. This may facilitate the step of assigning all of the other buses to reference generator.

All of the other buses may be assigned to reference generator buses according to the largest value of the calculated proximities in the matrix J_{g} for that respective bus. This may provide a computationally efficient method of assigning all of the other buses to reference generator buses.

The step of determining the islanding solution may comprise:
building a static graph G_{SA} containing only the nodes that belong to the weak areas, the boundary nodes and the edges that connect these nodes within the weak area; and
determining the islanding solution by considering only the power flows over the connections represented by those edges, wherein determining the islanding solution comprises selecting connections to be disconnected based on a calculated minimal power-flow disruption between future islands and the utilization of graph theory based clustering algorithms.

Determining the islanding solution by only considering power flows over connections represented by edges located in weak areas significantly decreases the number of connections that are considered when determining the islanding solution. Therefore, the speed with which the islanding solution can be determined is significantly increased.

The graph theory based clustering algorithm may comprise spectral clustering. For example, the graph theory based clustering algorithm may comprise the spectral clustering algorithm disclosed in A. V. Luxburg, which algorithm is incorporated herein by reference. Of course, other graph theory based clustering algorithms may be used instead.

The islanding solution may be determined by applying a graph-theory based clustering algorithm to the static graph G_{SA}.

At least one further constraint in addition to minimal power-flow disruption may be applied when determining the islanding solution. By applying more than one constraint when determining the islanding solution it becomes feasible to capture the complexity involved in the intentional controlled islanding of practical power systems. Examples of further constraints that may be applied include reactive power balance, thermal limits, availability of transmission lines, special circumstances, or any other criteria based on operational knowledge and experience.

### BRIEF DESCRIPTION OF THE DRAWINGS

Embodiments of the present invention will now be discussed, by way of example only, with reference to the accompanying Figures, in which:

FIG. 1 shows a single line diagram of a 9-bus electrical power system;

FIG. 2 shows a dynamic model of the electrical power system of FIG. 1;

FIG. 3 shows a graph in an r-dimensional Euclidian space illustrating the contribution of every bus in the electrical power system of FIG. 1;

FIG. 4 shows a representation of the elements of the electrical power system of FIG. 1 in each island and in the identified weak area;

FIG. 5 shows a static graph of the power flows in the weak area of FIG. 4;

FIG. 6 shows a schematic illustration of the final splitting strategy determined from the static graph of FIG. 5.

### DETAILED DESCRIPTION OF THE PREFERRED EMBODIMENTS, FURTHER OPTIONAL FEATURES OF THE INVENTION

An embodiment of the present invention comprises a two-step method for the prevention of blackouts in a power system by splitting it into r islands, i.e. by creating r strong internally connected islands with the minimal power flow disruption.

Large power systems inevitably contain groups of generators that are more coherent with one another than with the other generators in the system. These generator groups swing against one another in the form of oscillations in their instantaneous generation. The intrinsic link between these oscillations and the concept of weak connections (WCs) is described in J. H. Chow (Time-Scale Modeling of Dynamic Networks with Applications to Power Systems vol. 46. New York: Springer-Verlag, 1982), which is incorporated herein by reference.

Islanding seeks to prevent a blackout by separating the generators that are not coherent and eliminating the source of the oscillations that are threatening the stability of the system. Minimising the power flow disruption that occurs during this separation will in turn minimise the disturbance experienced by each island at the time of separation. This will serve to reduce the post disturbance oscillations within each island and increase the likelihood that the islands will survive as isolated power systems.

Previous islanding methods have used the existence of WCs to separate generator groups. However, embodiments of the present invention extend these WCs to define a set of weak areas (WAs) that separate the coherent groups. Extending the WCs into WAs allows an additional criterion, expressed in the form of an objective function, to be considered when designing the islanding strategy. This is of great benefit as simply using the WCs would design an islanding strategy based on only one of the many constraints that must be considered when creating stable power system islands.

In the first stage of an embodiment of the present invention graph theory is used to define a dynamic graph that may represent the dynamic properties of the considered power system. These are: synchronising coefficients, power flows and sources of inertia within the entire system. In this embodiment, this dynamic graph is used to identify the WAs based on the similarity of each bus in the system to one of the r reference generators.

In the second stage of an embodiment of the present invention graph theory is used to define a set of static graphs that describe the power flow in each of the WAs. The graph theory method of spectral clustering may then be applied to these static graphs to identify the solution that will allow each coherent group to be separated from the others with the minimal power flow disruption. The edges (in reality transmission lines) identified by this process will define the final splitting strategy (FSS).

Only the WAs are considered when searching for this FSS. This dramatically reduces the searching space considered, and consequently the execution time, with no loss of information; as the contributions of every bus in the system are considered in the first stage.

The following is a detailed description of the potential execution of this embodiment.

Power System and Graph Properties

The following parameters define the properties of the considered electrical power system:
n_{b} is the total number of buses in the power system
n_{g} is the number of generators in the power system
θ is the vector of angles of the n_{b} buses
δ is an n_{g}-state vector of machine angles
Vᵣ is an n_{b}-vector of the real component of the bus voltages
Vₓ is an n_{b}-vector of the imaginary component of the bus voltages
V=[Vᵣ Vₓ]^{T}
f( ) is an n_{g}-vector of accelerating power
g( ) is the load-flow equation
H is the inertia constant
ω₀ is the nominal system frequency
M is an n_{g}×n_{g} diagonal matrix of terms defined as (2H_{g}/ω₀)

Graph theory is integral to embodiments of the invention and a basic graph can be defined as follows:

G=(V, E)

The elements vᵢ ε V, i=1, 2, . . . , n_{b}, and eᵢⱼ ε E ⊂ V×V, i, j=1, 2, . . . , n_{b}, denote the nodes (vertices) and edges (links) in the graph G, respectively. The sets V and E represent the buses and branches (branches include both transmission lines and transformers) of the electrical power system, respectively. The graph can be extended to include weight factors associated with the nodes and edges. This weighted graph can be defined as follows:

G=(V, E, u, w)

The elements uᵢ=u(vᵢ), i=1, 2, . . . , n_{b} and wᵢⱼ=w(eᵢⱼ), i, j=1, 2, . . . , n_{b}, represent the weight factor associated with each node vᵢ ε V and each edge eᵢⱼ ε E, respectively.

Representing the graph using matrices allows particular features of the graph to be identified. For example, the Laplacian matrix of a graph is commonly used in graph partitioning methods. The Laplacian matrix of the graph G can be defined as follows:

L=D−W

where D is the degree matrix, which is a diagonal matrix of terms defined as dᵢ=Σⱼ₋₁ⁿ^{_{b}}wᵢⱼ, and W is the weighted adjacency matrix, in which the ij-th entry is defined as wᵢⱼ.

The eigenvalues and eigenvectors of the matrix L, which represents the graph G, are used to partition the graph into a number of disjoint subsets. The use of the eigenvalues and eigenvectors to embed the graph G in the Euclidean space is a graph theory method named spectral embedding (see A. V. Luxburg, (“A tutorial on spectral clustering”, Statistics and Computing, vol. 17, no. 4, pp. 395-416, December 2007), which is incorporated herein by reference).

Identifying Generator Coherency and Weak Areas

The first step of embodiments of the present invention can involve using a graph representing the synchronising coefficients between the generators in the system to identify r groups of coherent generators. The WAs that separate these coherent groups can then be identified using a graph of the contribution of each bus in the system to the oscillatory modes.

The graphs of synchronising coefficients and dynamic coupling represent the dynamic behaviour of a linearised classical second order power system model. The dynamic properties of the entire power system can be described as follows:

M\ddot{δ}=f(δ,V)

0=g(δ,V) (1)

Linearising equation (1) about an operating point δ₀, V₀ obtains:

$$\begin{matrix}Δ \ddot{δ} = \frac{\partial f ( δ , V )}{\partial δ} {\vert}_{{A}_{0} , {V}_{0}} Δδ + \frac{\partial f ( δ , V )}{\partial V} {\vert}_{{A}_{0} , {V}_{0}} Δ V = {J}_{A} Δδ + {J}_{B} Δ V & ( 2 ) \\ 0 = \frac{\partial g ( δ , V )}{\partial δ} {\vert}_{{A}_{0} , {V}_{0}} Δδ + \frac{\partial g ( δ , V )}{\partial V} {\vert}_{{A}_{0} , {V}_{0}} Δ V = {J}_{C} Δδ + {J}_{D} Δ V & ( 3 )\end{matrix}$$

which can be expressed in this matrix form:

$$[ \begin{matrix}Δ \ddot{δ} \\ 0\end{matrix} ] = [ \begin{matrix}{J}_{A} & {J}_{B} \\ {J}_{C} & {J}_{D}\end{matrix} ] [ \begin{matrix}Δδ \\ Δ v\end{matrix} ] \qquad ( 4 )$$

where J_{A}, J_{B}, J_{C}, J_{D} are Jacobian matrices comprised of the partial derivatives of the terms in equation (1).

The dynamic model of a power system can be represented using a dynamic graph, consisting of two dynamic subgraphs:

$${G}_{D} = ( {V}_{D} , {E}_{D} , {U}_{D} , {W}_{D} ) = ( {V}_{D 1} ⋃ {V}_{D 2} , {E}_{D 1} ⋃ {E}_{D 2} , {U}_{D 1} ⋃ {U}_{D 2} , {W}_{D 1} ⋃ {W}_{D 2} ) \qquad ( 5 )$$

where:
the elements v_{D1,i} ε V_{D1} denote nodes of the first dynamic graph, which represents the power system reduced to only the internal generator buses, when each generator is modelled using a classical 2^{nd} order generator model;
the elements v_{D2,i} ε V_{D2} denote nodes of the second dynamic graph, which represents the whole dynamic power system;
the elements e_{D1,ij} ε E_{D1} denote edges of the first dynamic graph, which represent the connections between the internal buses of the machines. The admittances of these connections can be found by performing Kron reduction of the admittance matrix of the full power system extended to the internal generator buses (Kron reduction may also be known as a Ward equivalent or a Schur reduction and is discussed in F. Dorfler et al. (Kron Reduction of Graphs With Applications to Electrical Networks, IEEE Trans. On Circ. and Syst., vol 60, no. 1, 2013), which is incorporated herein by reference);
the elements e_{D2,ij} ε E_{D2} denote edges of the second dynamic graph, which represent the connections between the buses (transmission lines, cables, power transformers) of the whole dynamic power system.
the values u_{D1,i}=u_{D1}(v_{D1,i}) denote weight factors associated with the nodes of the first dynamic graph, that represent the inertia constants of the generation at each bus;

u_{D1,i}=2Hᵢ/ω₀ (6)
the values u_{D2,i}=u_{D2}(v_{D2,i}) denote weight factors associated with the nodes of the second dynamic graph, that represent the inertia constants of the buses of the whole dynamic graph;

u_{D2,i}=0 (7)
the values w_{D1,ij}=w_{D}(e_{D1,ij}) denote weight factors representing the synchronising coefficients between connected buses, associated with the edges of the first dynamic graph, when considering only the internal generator buses;

$${w}_{D 1 , ij} = {w}_{D 1 , ji} = \{ \begin{matrix}\frac{\partial {P}_{ij}}{\partial {δ}_{ij}} = \vert {V}_{i} \vert \vert {V}_{j} \vert {b}_{ij} cos ( {δ}_{i} - {δ}_{j} ) & if {e}_{D 1 , ij} ∈ {E}_{D 1} \\ 0 & otherwise\end{matrix} \qquad ( 8 )$$

where ∂Pᵢⱼ/∂δᵢⱼ is the synchronizing coefficient between buses i and j, Vᵢ and Vⱼ are the bus voltage magnitudes at buses i and j, respectively, bᵢⱼ are the imaginary entries of the reduced admittance matrix and δᵢ and δⱼ are the rotor angle at machine buses i and j, respectively.
the values w_{D2,ij}=w_{D2}(e_{D2,ij}) denote weight factors representing the dynamic coupling between load buses, associated with the edges of the second dynamic graph;

$$\begin{matrix}{w}_{D 2 , ij} = {w}_{D 2 , ji} \\ = \{ \begin{matrix}\frac{\partial {P}_{ij}}{\partial {θ}_{ij}} = \vert {V}_{i} \vert \vert {V}_{j} \vert {b}_{ij} cos ( {θ}_{i} - {θ}_{j} ) & if {e}_{D 2 , ij} ∈ {E}_{D 2} \\ 0 & otherwise\end{matrix}\end{matrix} \qquad ( 9 )$$

where ∂Pᵢⱼ/∂θᵢⱼ is the dynamic coupling between buses i and j, Vᵢ and Vⱼ are the bus voltage magnitudes at buses i and j, respectively, bᵢⱼ are the imaginary entries of the admittance matrix and θᵢ and θⱼ are the bus voltage phases at buses i and j, respectively.

The system state matrix A can be calculated based on this graph:

$$\begin{matrix}A = {[ M ]}^{- 1} {L}_{D 1} \\ where , & ( 10 ) \\ {[ M ]}_{ij} = diag ( {u}_{D 1 , 1} , {u}_{D 1 , 2} , … , {u}_{D 1 , {n}_{g}} ) & ( 11 ) \\ {[ {L}_{D 1} ]}_{ij} = \{ \begin{matrix}- {w}_{D 1 , ij} & i \neq j \\ - {\sum }_{i = 1 , i \neq 1}^{{n}_{g}} {w}_{D 1 , ij} & i = j\end{matrix} & ( 12 )\end{matrix}$$

The r eigenvectors associated with the r smallest eigenvalues of the system state matrix A are calculated as they describe the contribution of each generator to each mode.

These eigenvectors and eigenvalues can be calculated by solving the eigenproblem of equation (13). The Lanczos algorithm can be implemented to find the eigenvalues and eigenvectors (for example, see Callum et al (J. K. Callum and R. A. Willoughby, (Lanczos Algorithms for Large Symmetric Eigenvalue Computations: Volume 1, Theory), vol 1, ISBN: 0898715237, 2002)). Lanczos can be chosen for this task as it is particularly effective when performing the decomposition of the very large sparse matrices encountered during power system calculations. Of course, algorithms other than the Lanczos algorithm may be used to solve the eigenproblem.

Aφ=λφ (13)

Placing the eigenvectors φ₁, φ₂, . . . , φᵣ as columns creates the eigenbasis matrix Q, which contains the coordinates of the generator nodes (the angle of the internal voltage of the machines, i.e. the voltage behind the transient reactance in the second order model), in the r-dimensional Euclidean space. Applying Gaussian elimination with complete pivoting to Q identifies the r reference machines.

The r generator eigenvectors can then be used to calculate the r eigenvectors that describe the contribution of the n_{b} non-generator buses to each mode as follows. To determine this contribution, the matrices L_{C} and L_{D} must be computed first.

$$\begin{matrix}{[ {L}_{C} ]}_{ij} = \{ \begin{matrix}- {w}_{D 2 , ij} & \begin{matrix}if {v}_{D 2 , i} is the terminal bus and \\ {v}_{D 2 , j} is the internal generator bus\end{matrix} \\ 0 & otherwise\end{matrix} & ( 14 ) \\ {[ {L}_{D} ]}_{ij} = \{ \begin{matrix}- {w}_{D 2 , ij} & \begin{matrix}if {v}_{D 2 , i} and {v}_{D 2 , j} are not internal \\ generator buses \end{matrix} \\ - {\sum }_{l = 1 , l \neq i}^{{n}_{b} + {n}_{g}} {w}_{D 2 , il} & i = j\end{matrix} & ( 15 )\end{matrix}$$

And the contribution of the load buses can be derived as follows:

φᵥᵢ=−L_{D}⁻¹L_{C}φᵢ (16)

When the eigenvectors φᵥᵢ are computed, the eigenbasis matrix [Q Qᵥ]^{T} can be obtained. However, to be consistent with the use of generator angles in the definition of Q, the argument of φᵥᵢ (see equation (17)) can be used to obtain the eigenbasis matrix [Q θ_{c}]^{T}. This eigenbasis matrix corresponds to the coordinates of the internal voltage of the machines and the buses of the power system, respectively.

$${θ}_{vi} = \frac{{V}_{ri} {u}_{Vri} - {V}_{xi} {u}_{Vxi}}{\vert V {\vert}^{2}} \qquad ( 17 )$$

Therefore, the contribution of every bus in the system to the modes can then be described using a graph in the r dimensional Euclidean space.

This graph can be used to identify the WAs by clustering each bus to one of the reference generators identified above. To do this, the cosine similarity can be applied between the reference vectors ρᵢ (the vector representing the reference generators) and the non-reference vectors ρⱼ to create the similarity matrix C, where the ij-th entry, denoted by, c(i, j), represents the measure of proximity between the corresponding data-points in the r-dimensional Euclidean space.

$$c ( i , j ) = \frac{{ρ}_{i} \cdot {ρ}_{j}^{T}}{\vert \vert {ρ}_{i} \vert \vert \cdot \vert \vert {ρ}_{j} \vert \vert} , \begin{matrix}i = r + 1 , … , ( {n}_{b} + {n}_{g} - r ) \\ j = 1 , … , r \end{matrix} \qquad ( 18 )$$

The matrix C can be used to assign each bus to a reference generator according to the largest entry in each row of C. Through this process the sets V_{D1}, V_{D2}, . . . , V_{Dr} can be created. The edges that link two buses that are assigned to different reference generators, i.e. they are in different sets, are the WCs. The WAs are identified by extending the WCs based on the strength of the connectivity of each bus with the rest of their set.

A bus will be assigned to the weak area between its set and another set if the relevant entries in C are sufficiently similar, where similarity is determined by a threshold ε. For example, let the i-th bus in V_{D} be a member of the set V_{Dk}. This bus is then assigned to the weak area between the k-th and l-th island (represented by V_{Dk} and V_{Dl}, respectively) if the following inequality is satisfied:

(1−ε)C(i,k)≦C(i,l)≦(1+ε)C(i,k) (19)

where, by the definition of the membership of the i-th bus, C(i,k) is the largest element in the i-th row of C and C(i,l) corresponds to the entry for the I-th reference generator/island.

This process can be repeated for the members of each set and is equivalent to testing if the largest value in a row of C lies within a margin c of the next largest value in that row.

Identifying the Final Splitting Strategy (FSS) with Minimum Power Flow Disruption Using the Static Graph

When the WAs are defined, the FSS with minimum power flow disruption can be identified using the static graphs that describe the power flow in these WAs. It should be noted that there will be as many static graphs as identified WAs.

This static graph can be used to represent the power flow in each branch of the WAs:

G_{S}=(V_{S}, E_{S}, w_{S}) (20)

where:
the elements vᵢ ε V_{S} denote nodes of the static graph, which represent the buses within the WAs and the boundary buses (the boundary buses are those nodes that belong to an island but are connected to a node in a WA, see buses 4, 5 and 9 in FIG. 4);
the elements eᵢⱼ ε E_{S} denote the edges of the static graph, which represent those lines in the WA i.e. those lines connecting the buses within the WAs with one another and the boundary buses;
the values wᵢⱼ=w_{S}(eᵢⱼ) denote weight factors, representing the absolute power flow in the lines between the buses within the WAs and the boundary buses, associated with the edges of the static graph;

$${w}_{ij} = {w}_{ji} = \{ \begin{matrix}\frac{\vert {P}_{ij} \vert + \vert {P}_{ji} \vert}{2} & if {e}_{ij} ∈ {E}_{s} \\ 0 & otherwise \end{matrix} \qquad ( 21 )$$

where Pᵢⱼ and Pⱼᵢ in equation (21) are the active power in the transmission line connecting nodes i and j.

The Laplacian of the graph can then be used to cluster the buses in each WA to one of the islands based on the following objective function:

$$FSS = min {\sum }_{{e}_{ij} ∈ {E}_{SAW}} {w}_{ij} \qquad ( 22 )$$

where the set E_{SAW} means only edges within the WAs are considered when defining the FSS.

To solve equation (19), the graph theory method of spectral clustering can be used. This method uses the Laplacian matrix of the graph (see equation (23)).

L_{S}=D_{S}−W_{S} (23)

Given L_{S}, the un-normalized spectral clustering algorithm is summarized as follows, for the case of bisection (see A. V. Luxburg):
(1) Compute the un-normalized Laplacian Matrix L_{S} (see equation (23)).
(2) Compute the first two eigenvectors [symbol] ₁ and [symbol] ₂, associated with the two smallest eigenvalues, of the Eigen-problem L_{S} [symbol] =λ [symbol] .
(3) Let X be the matrix containing the vectors [symbol] ₁ and [symbol] ₂ as columns.
(4) For i=1, . . . , n_{b}, let xᵢ be the vector corresponding to the i-th row of X.
(5) Cluster the nodes xᵢ into two disjoint sets V_{S1} and V_{S2} using the k-medoids algorithm (see L. Kaufman et al (Finding groups in data: an introduction to cluster analysis. New York: Wiley 1990), which is incorporated herein by reference).

The output of this final stage describes the FSS

### EXAMPLE

System and Graph Properties

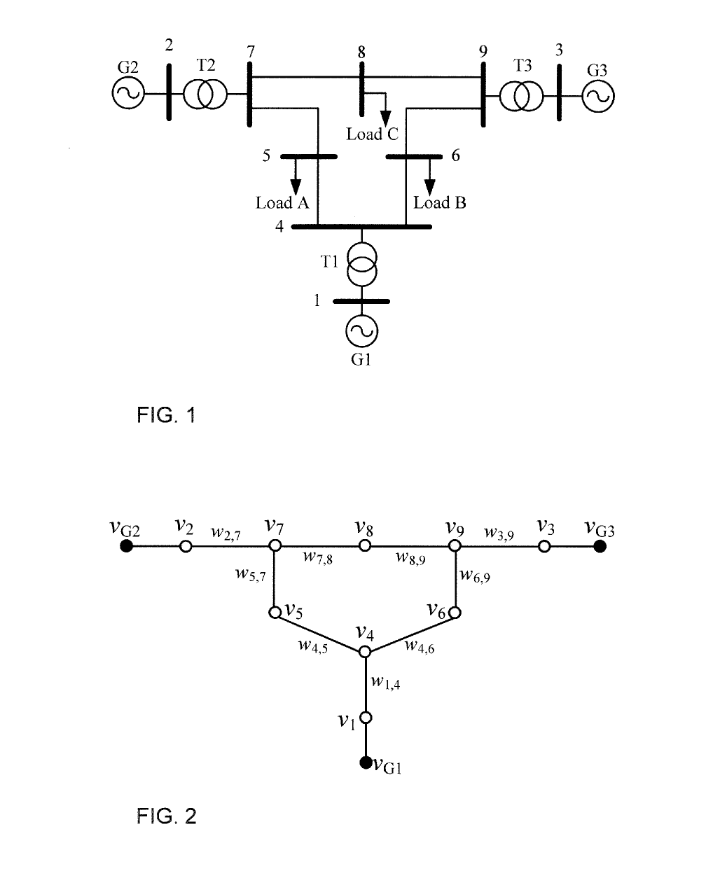

The nine-bus test system example shown in FIG. 1 is used to detail the embodiment. The test system can be found in P. M. Anderson and A. A. Fouad, Power System Control and Stability, 2^{nd} ed. New York: IEEE Press, 2003, which is incorporated herein by reference.

Identifying Generator Coherency and WAs

The dynamic properties of the entire power system are described using equation (4). This model can be represented using the dynamic graph illustrated in FIG. 2.

The r eigenvectors associated with the r smallest eigenvalues are calculated as they describe the contribution of each generator to each mode (eq. equation (12) is solved), as shown in the following table.

| | First eigenvector | Second eigenvector |
|---|---|---|
| G1 | 0.5774 | −0.3825 |
| G2 | 0.5774 | 1.0000 |
| G3 | 0.5774 | 0.5729 |

Gaussian elimination is then applied to determine the reference generators. The results of the Gaussian elimination reflect that the two reference generators are G2 and G1, as shown in the following table (in which the second and third columns represent the results of the Gaussian elimination).

| | | |
|---|---|---|
| G2 | 1 | 0.5774 |
| G1 | 0 | 0.7983 |
| G3 | 0 | 0.2466 |

The r eigenvectors that describe the contribution of the non-generator buses to each mode are then calculated using equations (14)-(17). The eigenbasis θᵥ is shown in the table below.

| | First eigenvector | Second eigenvector |
|---|---|---|
| 1 | 0.5774 | −0.1829 |
| 2 | 0.5774 | 0.6938 |
| 3 | 0.5774 | 0.4435 |
| 4 | 0.5774 | 0.0094 |
| 5 | 0.5774 | 0.1841 |
| 6 | 0.5774 | 0.1462 |
| 7 | 0.5774 | 0.5237 |
| 8 | 0.5774 | 0.4717 |
| 9 | 0.5774 | 0.3999 |

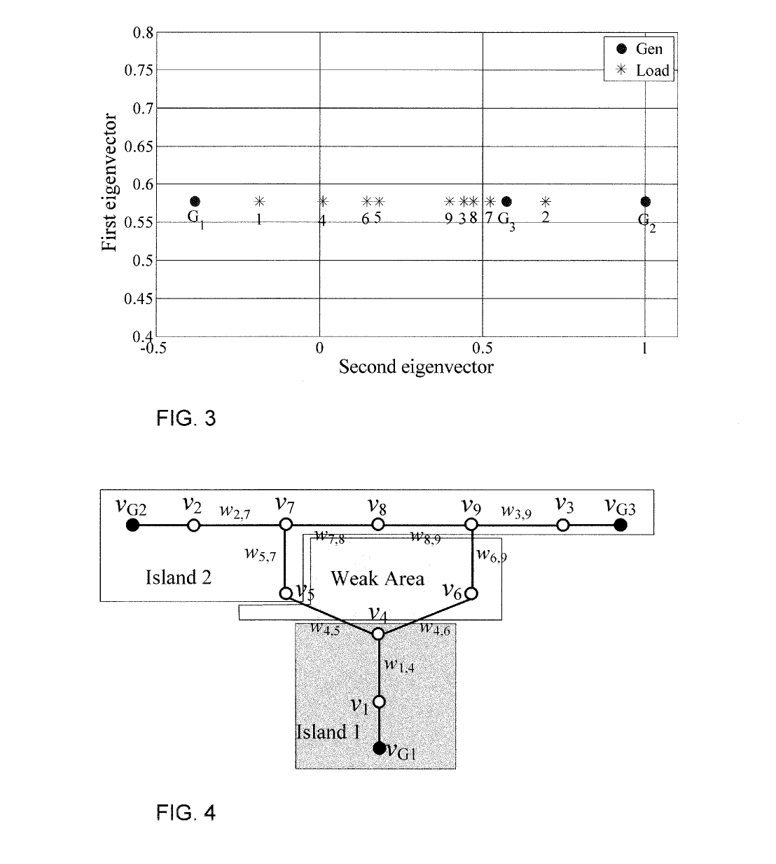

The contribution of every bus in the system can then be described using a graph in an r dimensional Euclidean space, as illustrated in FIG. 3. The contribution of a bus may mean the contribution of that bus to the spatial allocation of the load buses in Euclidian space.

The eigenbasis matrix can be used to identify the WAs by clustering each bus to a reference generator. To assign the non-reference generator to a reference generator, the measure of proximity (cosine similarity) is applied, as shown in the following table.

| Element in the | Cosine | Cosine |
|---|---|---|
| system | similarity to G2 | similarity to G1 |
| G1 | 0.0615 | 1 |
| G2 | 1 | 0.0615 |
| G3 | 0.9649 | 0.2027 |
| 1 | 0.2151 | 0.9615 |
| 2 | 0.9855 | 0.1087 |
| 3 | 0.9241 | 0.3246 |
| 4 | 0.5140 | 0.8245 |
| 5 | 0.7394 | 0.6265 |
| 6 | 0.6973 | 0.6726 |
| 7 | 0.9522 | 0.2464 |
| 8 | 0.9351 | 0.2961 |
| 9 | 0.9041 | 0.3708 |

The system threshold can then be applied to define the WA using equation (19) (note that one WA will be created as r=2). A threshold of 20% (10% on each side, i.e. ε=0.1) is considered appropriate for this specific example. Applying this value, the WA is found to be as shown in FIG. 4.

Identifying the Final Splitting Strategy (FSS) with Minimum Power Flow Disruption Using the Static Graph

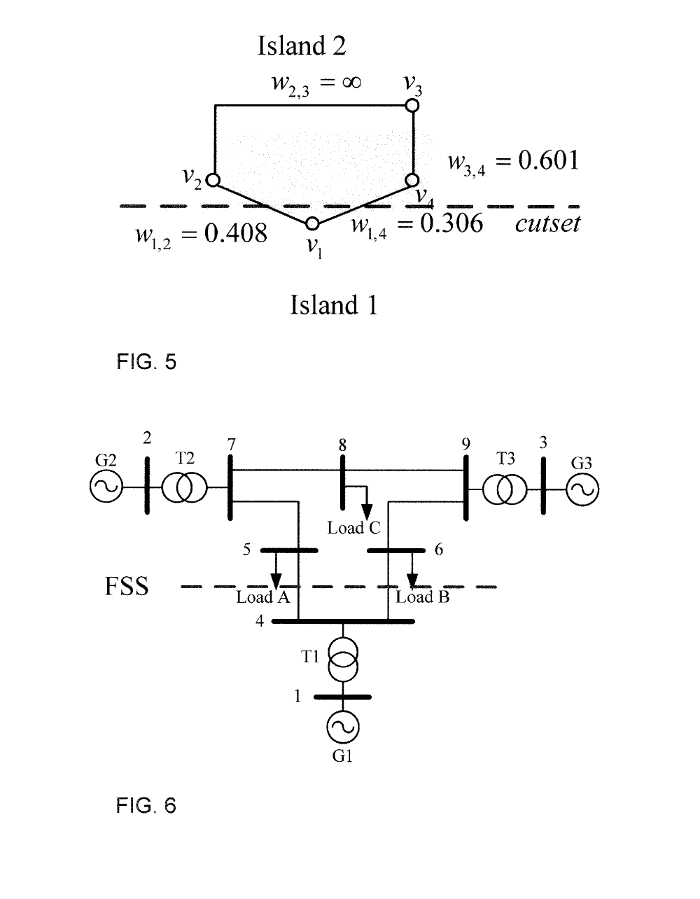

The power flow in each of the WAs can be described using a graph, as illustrated in FIG. 5. When the WA is identified, the boundary buses and the buses within the WA must be defined. As noted in FIG. 4, the boundary nodes are: v₄, v₅ and v₉, and the bus in the WA is v₆. The static graph is then built as illustrated in FIG. 5.

The Laplacian of the graph can be used to cluster the buses in each WA to one of the islands based on the objective function (see equation (22)). The Laplacian matrix can be built for the graph in FIG. 5. The eigenvalues and eigenvectors can then be computed, as shown in the following table, and the two smallest eigenvalues produce the following eigenvectors.

| | First | Second |
|---|---|---|
| Element | eigenvector | eigenvector |
| 1 | 0.5 | 0.849096 |
| 2 | 0.5 | −0.18097 |
| 3 | 0.5 | −0.44151 |
| 4 | 0.5 | −0.22662 |

The output of this final stage describes the final splitting strategy (FSS) which is found to be across the lines 4-5 and 4-6 in FIG. 1, as illustrated in FIG. 6.

1. A method of determining an islanding solution that separates an electrical power system comprising a plurality of generator buses and load buses into r electrically isolated islands, the method comprising:
representing the synchronising coefficients between the generators of the power system and the coupling between each load bus and each generator of the power system as a dynamic graph G_{D}=(V_{D}, E_{D}, U_{D}, W_{D});
calculating the first r eigenvalues and eigenvectors of a graph laplacian that describes the synchronising coefficients between the generators of the power system;
identifying r reference generator buses by applying an algorithm capable of determining the most centralised data-point in the r-dimensional Euclidian space to the first r eigenvectors;
calculating the r eigenvectors that describe the dynamic coupling between each of the load buses and each of the r reference generators using the r synchronising coefficient eigenvectors and the dynamic graph;
using the r synchronising coefficient eigenvectors and the r load dynamic coupling eigenvectors to compute a measure of proximity between each reference generator and all of the other buses to calculate the proximities between each reference generator and all of the other buses;
assigning all of the other buses to reference generators according to the calculated proximities;
selecting a system threshold based on the desired size of the weak areas;
identifying buses in weak areas by applying the selected system threshold to the calculated proximities to identify buses having a proximity to their assigned reference generator that is sufficiently similar to their proximity to another reference generator;
determining the islanding solution by selecting connections to be disconnected to split the power system into two or more islands based on an analysis of power flows only on connections to, or between, the buses identified as being in weak areas.

2. The method according to claim 1, wherein the dynamic graph G_{D}=(V_{D}, E_{D}, U_{D}, W_{D}) comprises two dynamic sub-graphs:
$$\begin{matrix}{G}_{D} = ( {V}_{D} , {E}_{D} , {U}_{D} , {W}_{D} ) \\ = ( {V}_{D 1} ⋃ {V}_{D 2} , {E}_{D 1} ⋃ {E}_{D 2} , {U}_{D 1} ⋃ {U}_{D 2} , {W}_{D 1} ⋃ {W}_{D 2} )\end{matrix}$$
wherein:
the elements v_{D1,i} ε V_{D1} denote nodes of the first dynamic sub-graph, which represents the power system reduced to only the internal generator buses, when each generator is modelled using a classical 2^{nd} order generator model;
the elements v_{D2,i} ε V_{D2} denote nodes of the second dynamic sub-graph, which represents the whole dynamic power system;
the elements e_{D1,ij} ε E_{D1} denote edges of the first dynamic sub-graph, which represent the connections between the internal buses of the machines;
the elements e_{D2,ij} ε E_{D2} denote edges of the second dynamic sub-graph, which represent the connections between the buses of the whole dynamic power system;
the values u_{D1,i}=u_{D1}(v_{D1,i}) denote weight factors associated with the nodes of the first dynamic sub-graph, that represent the inertia constants of the generation at each bus;
the values u_{D2,i}=u_{D2}(v_{D2,i}) denote weight factors associated with the nodes of the second dynamic sub-graph, that represent the inertia constants of the buses of the whole dynamic graph;
the values w_{D1,ij}=w_{D}(e_{D1,ij}) denote weight factors representing the synchronising coefficients between connected buses, associated with the edges of the first dynamic sub-graph, when considering only the internal generator buses;
the values w_{D2,ij}=w_{D2}(e_{D2,ij}) denote weight factors representing the dynamic coupling between load buses, associated with the edges of the second dynamic graph.

3. The method according to claim 2, wherein the method comprises determining the graph laplacian, A, that describes the synchronising coefficients between the generators of the power system by the following equation:
$$A = {[ M ]}^{- 1} {L}_{D 1}$$
$$where {\text{:} \\ [ M ]}_{ij} = {diag ( {u}_{D 1 , 1} , {u}_{D 1 , 2} , … , {u}_{D 1 , {n}_{g}} ) \\ [ {L}_{D 1} ]}_{ij} = \{ \begin{matrix}- {w}_{D 1 , ij} & i \neq j \\ - {\sum }_{l = 1 , l \neq 1}^{{n}_{g}} {w}_{D 1 , ij} & i = j\end{matrix}$$

4. The method according to claim 2, wherein calculating the r eigenvectors that describe the dynamic coupling between each of the load buses and each of the r reference generators comprises first computing the matrices L_{C} and L_{D} by the following equations:
$${[ {L}_{C} ]}_{ij} = \{ {\begin{matrix}- {w}_{D 2 , ij} & \begin{matrix}if {v}_{D 2 , i} is the terminal bus and \\ {v}_{D 2 , j} is the internal generator bus\end{matrix} \\ 0 & otherwise\end{matrix} \\ [ {L}_{D} ]}_{ij} = \{ \begin{matrix}- {w}_{D 2 , ij} & \begin{matrix}if {v}_{D 2 , i} and {v}_{D 2 , j} are not \\ internal generator buses \end{matrix} \\ - {\sum }_{l = 1 , l \neq i}^{{n}_{b} + {n}_{g}} {w}_{D 2 , il} & i = j\end{matrix}$$

5. The method according to claim 4, wherein the r eigenvectors that describe the dynamic coupling between each of the load buses and each of the r reference generators are determined by the following equation:
φᵥᵢ=−L_{D}⁻¹L_{C}φᵢ
where φᵢ are the synchronising coefficient eigenvectors.

6. The method according to claim 1, wherein the method comprises determining the graph laplacian, A, that describes the synchronising coefficients between the generators of the power system by the following equation:
A=J_{A}−J_{B}J_{D}⁻¹J_{C}
where the matrices J_{A}, J_{B}, J_{C} and J_{D} are determined from the following equation:
$$[ \begin{matrix}Δ \ddot{δ} \\ 0\end{matrix} ] = [ \begin{matrix}{J}_{A} & {J}_{B} \\ {J}_{C} & {J}_{D}\end{matrix} ] [ \begin{matrix}Δδ \\ Δ v\end{matrix} ]$$
where δ is an n_{g}-state vector of machine angles for the power system and V=[Vᵣ Vₓ]^{T}, where Vᵣ is an n_{b}-vector of the real component of the bus voltages of the power system and Vₓ is an n_{b}-vector of the imaginary component of the bus voltages of the power system.

7. The method according to claim 1, wherein the method comprises forming an eigenbasis matrix J with the first r eigenvectors of the graph laplacian placed as column vectors before identifying the r reference generator buses.

8. The method according to claim 7, wherein identifying the r reference generator buses comprises applying Gaussian elimination with complete pivoting to the eigenbasis matrix J.

9. The method according to claim 1, wherein the measure of proximity computed between each reference generator and all of the other buses comprises the cosine similarity.

10. The method according to claim 1, wherein the system threshold is selected to identify buses having a calculated proximity to their assigned reference generator that is within ±10%, ±20% or ±50% of their proximity to another reference generator.

11. The method according to claim 1, wherein a matrix J_{g} is formed by applying the measure of proximity between each reference generator and all of the other buses.

12. The method according to claim 11, wherein all of the other buses are assigned to reference generator buses according to the largest value of the calculated proximities in the matrix J_{g} for that respective bus.

13. The method according to claim 1, wherein the step of determining the islanding solution comprises:
building a static graph G_{SA} containing only the nodes that belong to the weak areas, the boundary nodes and the edges that connect these nodes within the weak area; and
determining the islanding solution by considering only the power flows over the connections represented by those edges, wherein determining the islanding solution comprises selecting connections to be disconnected based on a calculated minimal power-flow disruption between future islands and the utilization of graph theory based clustering algorithms.

14. The method according to claim 13, wherein the graph theory based clustering algorithm comprises spectral clustering.

15. The method according to claim 13, wherein the islanding solution is determined by applying a graph-theory based clustering algorithm to the static graph G_{SA}.

16. The method according to claim 13, wherein at least one further constraint in addition to minimal power-flow disruption is applied when determining the islanding solution.

17. (canceled)
